(19) United States
(12) Patent Application Publication
(10) Pub. No.: US 2013/0290334 A1
(43) Pub. Date: Oct. 31, 2013

(54) MANAGING STORAGE OF DATA ACROSS DISPARATE REPOSITORIES

(71) Applicant: Rahul KAPOOR, Bellevue, WA (US)

(72) Inventor: Rahul KAPOOR, Bellevue, WA (US)

(21) Appl. No.: 13/460,264

(22) Filed: Apr. 30, 2012

(51) Int. Cl. G06F 17/30

(52) U.S. Cl. 707/737; 707/E17.089

(57) ABSTRACT

In a method for managing storage of data across a plurality of disparate repositories, a partitioning strategy for storing the data into a plurality of partitions in at least one of a plurality of disparate repositories is acquired based upon a characteristic of the data. In addition, global metadata that, describes the partitioning strategy is acquired and the global metadata is implemented in a plurality of disparate repositories to enable performance of the partitioning strategy in storing the data in the plurality of partitions across the plurality of disparate repositories in a location agnostic manner.

### BACKGROUND

Data, such as electronic documents, e-mails, spreadspeets, financial data, etc., are commonly stored in a repository for various reasons, including ease of accessibility, compliance with legal, requirements, and/or for backup purposes. In addition, versioning schemes that enable the data ‘to be stored in several versions at the same time are typically implemented when the data is archived.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a data management environment, according to an example of the present disclosure;

FIGS. 2A-2C, respectively, illustrate diagrams of manners in which a partitioning strategy may be implemented on at least one of a plurality of repositories, according to examples of the present disclosure;

FIG. 3, shows a block diagram of an archiving system, according to an example of the present disclosure;

FIGS. 4A-4C, respectively, depict flow diagrams of methods for managing archiving of data into a plurality of partitions, according to examples of the present disclosure; and

FIG. 5 illustrates a schematic representation of a computing device, which may be employed to perform various functions of the data manager depicted in FIG. 3, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. In the present disclosure, the term “includes” means includes but not limited thereto, the term “including” means including but not limited thereto. The term “based on” means based at least in part on. In addition, the terms “a” and “an” are intended to denote at least one of a particular element.

As used throughout the present disclosure, the term “data” is generally intended to encompass electronic data, such as electronic mail (e-mail), word processing documents, spreadsheet documents, webpages, computer aided drawing documents, electronic file folders, database records, logs, sales information, patient information, etc. As also used herein, the terms “storage” and “storing” are generally intended to encompass archiving, backing up, or other saving of data.

As further used herein, an “on-premise repository” is generally intended to encompass a private repository onto which an organization stores their data and may comprise a local and/or a remote repository. In addition, the term “hosted repository” is generally intended to encompass a public repository that is hosted by a third party, such as a cloud-based data storage services provider.

Disclosed herein is a method for managing storage of data into a plurality of disparate repositories. Also disclosed herein are an apparatus for implementing the method and a non-transitory computer readable medium on which is stored machine readable instructions that implement the method.

As discussed in greater detail herein below, the method for managing storage of data into a plurality of disparate repositories comprises acquiring a partitioning strategy for storing the data into a plurality of partitions in at least one of the plurality of disparate repositories based upon a characteristic of the data, acquiring global metadata that describes the partitioning strategy, and implementing the global metadata in at least one of the plurality of disparate repositories to enable performance of the partitioning strategy in storing the data in the plurality of partitions across the plurality of disparate repositories. According to an example, each of the repositories in which the partitions are to be established implements the method to enable uniform application of the partitioning strategy, and thus, storage of the data across the plurality of partitions in a relatively seamless manner. In addition, the uniform application of the partitioning strategy enables searching, retrieval, and other administrative functions to be performed on the stored data in a relatively seamless manner. That is, for instance, the storage, searching, and retrieval of the data may be performed over the disparate repositories without regard to which of the disparate repositories the data is stored.

Through implementation of various examples of the present disclosure, data may be stored into the disparate repositories in a manner that is location agnostic to the user that is storing the data. According to an example, the data storage into the disparate repositories is initiated through a single interface or console, which may comprise, for instance, a common web portal through which users may perform administrative functions on the data to be stored on the disparate repositories and on data that is stored On the disparate repositories. In addition, the data may be stored through use of a common framework, which generally enables searching of the data stored in the disparate repositories to be performed concurrently through a single interface or console. Thus, the examples in the present disclosure may enable greater efficiency in the storage, searching, and retrieval of data; while enabling use of disparate repositories, which may result in the ability to maintain a high level of security on certain data while lowering costs associated with storing of other data. For instance, relatively important or critical data may be stored at an on-premise repository and less important or critical data may be stored at a hosted repository, which is generally less expensive to implement than the on-premise repository.

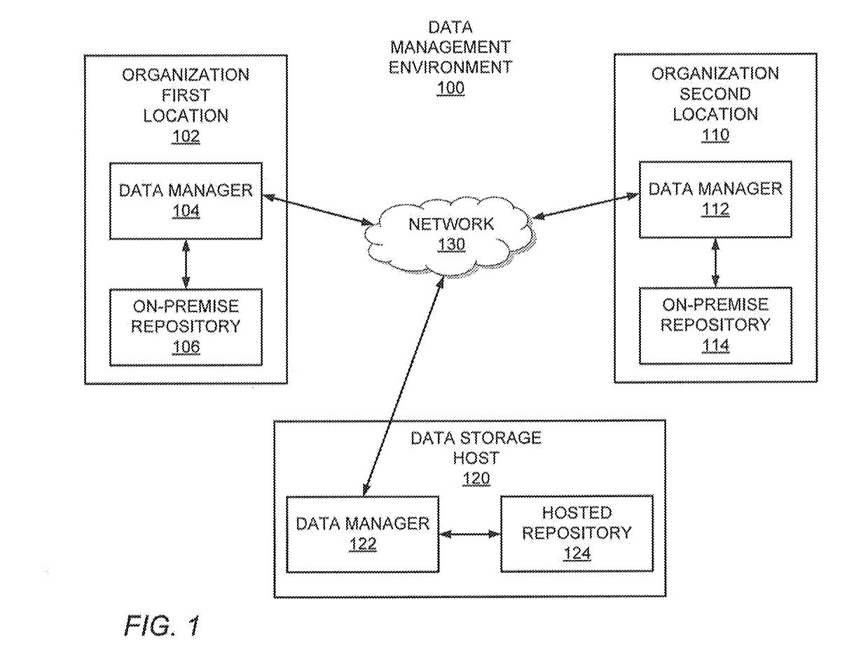

With reference first to FIG. 1, there is shown a block diagram of a data management environment 100, according to an example of the present disclosure. The data management environment 100 is depicted as including an organization first location 102, an organization second location 110, and a data storage host 120. In addition, the organization first location 102, the organization second location 110, and the data storage host 120 are depicted as being in communication with each other through a network 130. It should be understood that the data management environment 100 may include additional components and that one or more of the components described herein may be removed and/or modified without departing from a scope of the data management environment 100. For instance, the data management environment 100 may include any number of organization locations and/or data storage hosts connected through the network 130, which may also represent any number of sub-networks. In addition, although a single network 130 has been depicted in FIG. 1, it should be understood that the network 130 may comprise separate networks, such as for instance, a local area network (LAN) or a wide area network (WAN) between the organization first location 102 and the organization second location 110, and the Internet between the organization first location 102 and the organization second location 110 and the data storage host 120.

The organization first location 102 comprises, for instance, a base or main location in which an administrator of a particular organization may regularly store data. In addition, the organization second location 110 comprises, for instance, a location that is geographically separated from the first location 102, and may thus comprise a remote location with respect to the first location 102. By way of particular example, the organization first location 102 may be located in one state or country and the organization second location 102 may be located in another state or country. In any regard, the organization first location 102 may be in communication with the organization second location 110 through the network 130.

The data storage host 120 comprises a third party hosted data storage location. The data storage host 120 may thus comprise, for instance, a publicly available, cloud-based data storage provider, such as the Hewlett-Packard Company™, Amazon™, etc. In this regard, the data storage host 120 may comprise a data storage provider that may be accessed through the Internet through, for instance, a web portal. In addition, the data storage host 120 may store data of more than one organization in the same or different servers and may be in communication with the organization first location 102 and the organization second location 110 over the network 130.

As also shown in FIG. 1, the organization first location 102 is depicted as including a data manager 104 and an on-premise repository 106. The organization second location 110 is depicted as including a data manager 112 and an on-premise repository 114. The data storage host 120 is depicted as including a data manager 122 and a hosted repository 124. As discussed in greater detail herein below, the data managers 104, 112, and 122 are to implement partitioning strategies on their respective repositories. Particularly, the data managers 104, 112, and 122 are to implement the same partitioning strategy on the repositories 106, 114, and 124 to enable the data to be stored in the repositories 106, 114, and 124 in a transparent manner and to be retrieved through a common interface or console, also in a transparent manner to a user. Thus, for instance, when data is received by any of the data managers 104, 112, 122, the data is stored in the partition identified by the common partitioning strategy implemented in the data managers 104, 112, 122. Although not shown, the data to be stored may be received into the data managers 104, 112, 122 through a client device (not shown), in which the client device is either located within one of the organization locations 102, 110 or is connected to the data management environment 100 through the network 130. Likewise, any of the data managers 104, 112, 122 may provide a console through which a user may perform administrative operations in storing data and/or on the data stored in any of the repositories 106, 114, 124. The administrative operations may include, for instance, at least one of setting of retention policies, monitoring of job (e.g., indexing, disposition, etc.) statuses, searching for particular data in at least one of the repositories 106, 114, 124, etc.

Generally speaking, the partitioning strategy involves establishing partitions in at least one of the repositories 106, 114, and 124 that correspond to a logical separation of data to be stored in the partitions. In other words, the partitions comprise logical boundaries with respect to each other, in which no single instancing is permitted across partitions. The partitions may also be modified, for instance, moved, expanded, contracted, etc., as desired or necessary by modifying the logical boundaries of the partitions with respect to the hardware onto which they are established.

The logical separation or boundaries of the data may include separating the partitions according to the groups of users that own the data. A user or a group of users may be construed as “owning” data if the user or group of users created the data, modified the data, the data is relevant to the user or group of users, etc. Thus, for instance, a first partition may be assigned to a first group of users, a second partition may be assigned to a second group of users, and so forth. By way of example, the first group of users may comprise the users in an organization that are known to collaborate with each other such that the data owned by those users in the first group of users may be related in some manner. For instance, the first group of users may comprise users in an engineering department of an organization. In addition, the users in the second group of users may comprise users in the organization that are known to be generally separate from the users in the first group of users, and that the users in the second group of users may not substantially: collaborate with the users in the first group of users. For instance, the second group of users may comprise users in a warehouse of the organization. According to a particular example, the groups of users in the organization may be identified from information contained, for instance, in an active directory or other directory of the organization. In other examples, the groups of users may be user-defined and may evolve over time.

The partitioning strategy may include establishing the partitions such that the partitions are separated within a respective repository 106, 114, 124 or across multiple ones of the repositories 106, 114, 124. The repositories 106, 114, and 124 are generally comprised of various machines on which data is to be stored. In various implementations, the machines within a repository 106, 114, 124 may differ from each other, for instance, with respect to at least one of age, reliability, operating characteristic, efficiency, etc. As such, use of some of the machines within a repository 106, 114, 124 may be construed as being preferred over use of other machines within the repository 106, 114, 124. In these types of implementations, and according to an example, the partitioning strategy may include establishing the partitions, such that the partitions are assigned to store particular data based upon, for instance, the relative importance of the groups of users and/or the criticality of the data that they own with respect to each other. In this example, the data owned by groups of users that are considered to have a relatively higher importance and/or criticality are to be stored in the partitions assigned to the preferred machines and the data owned by groups of users that are considered to have a relatively lower importance and/or criticality are to be stored in the partitions assigned to other, less preferred, machines.

In instances where the partitions are separated across multiple ones of the repositories 106, 114, and 124, a partition within an on-premise repository 106, 114 may be preferred over a partition within a hosted repository 124, or vice versa. In one regard, the on-premise repository 106, 114 may be preferred because of higher security standards available on those on-premise repositories 106, 114 as compared with the hosted repository 124. In another regard, the hosted repository 124 may be relatively less expensive to implement and may thus be preferred for less sensitive or critical information. In addition, in various instances, a remote on-premise repository 114 may be relatively less expensive to implement than the local on-premise repository 106. According to an example, the partitioning strategy includes establishing the partitions, such that the partitions are assigned to store particular data based upon, for instance, the relative importance, sensitivity, and/or criticality of the data. In this example, for instance, the data owned by groups of users that are considered to have a relatively higher importance are to be stored in the partitions assigned to the on-premise repository 106 and the data owned by groups of users that are considered to have a relatively lower importance are to be stored in the partitions assigned to the hosted repository 124. In another example, the data owned by groups of users that are considered to have a relatively higher importance are to be stored in the on-premise repository 106 of the organization first location 102 and the data owned by groups of users that are considered to have a relatively lower importance are to be stored in the on-premise repository 114 of the organization second location 110.

According to an example, the partitioning strategy prevents single instancing of the data from occurring across partitions. That is, the partitioning strategy allows multiple copies of the same data to be stored into different partitions, with no attempt to optimize storage of the data by sharing data across the different partitions. In one regard, the single instancing of the data is done to substantially minimize cross-partition communication and thus enable the partitioning strategy to be scaled.

According to an example, global metadata that describes the partitioning strategy may be generated and may be implemented to enable performance of the partitioning strategy in storing the data in a plurality of partitions across a plurality of disparate repositories. In other words, the global metadata tracks what partitions are available and how the partitions are logically separated, for instance, depending upon a characteristic of the data. By way of example, the characteristic of the data includes at least one of an owner of the data, a type of the data, an identifier of the owner of the data, a group identifier of the data, etc. In addition, the global metadata includes information pertaining to which of the repositories 106, 114, 124 the data is to be stored. The global metadata may also include information pertaining to how data is to be routed, for instance, through the network 130, to reach the various partitions.

Each of the repositories 106, 114, 124 is to implement the same global metadata, and therefore, each of the repositories 106, 114, 124 may use the global metadata to make the same determinations as to which of the repositories data is to be stored and to direct the data to the appropriate partitions. More particularly, for instance, each of the repositories 106, 114, 124 may implement the same software and schema of storing data. In one regard, therefore, the same query mechanism for querying metadata may be employed to query each of the repositories 106, 114, 124. As such, the repositories 106, 114, 124 may be searched individually and/or collectively through a common interface and/or console.

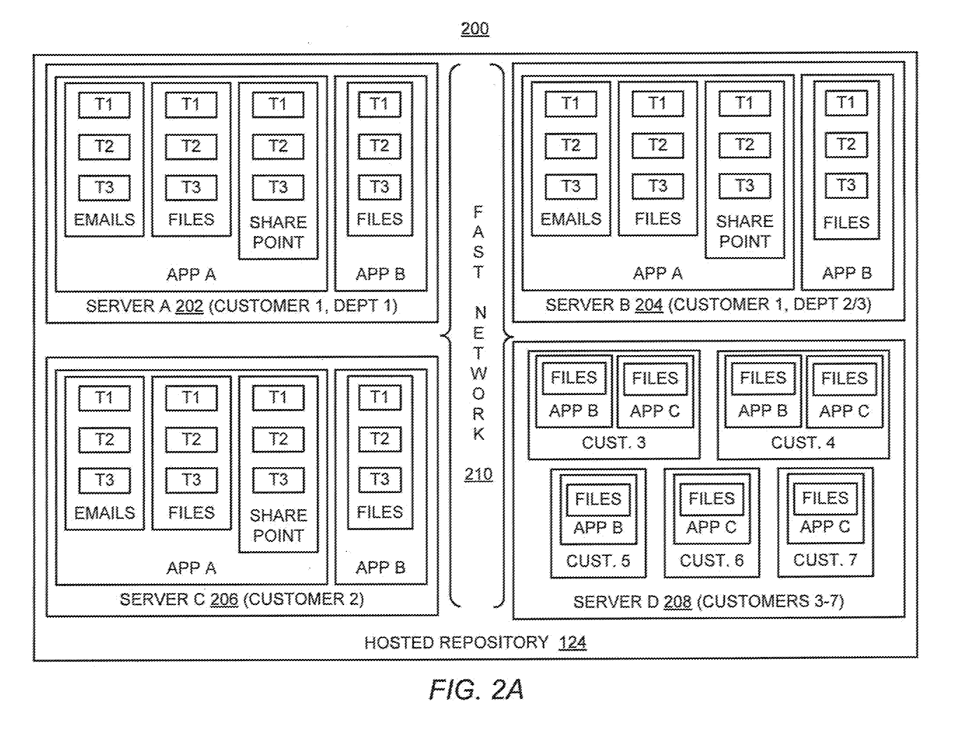

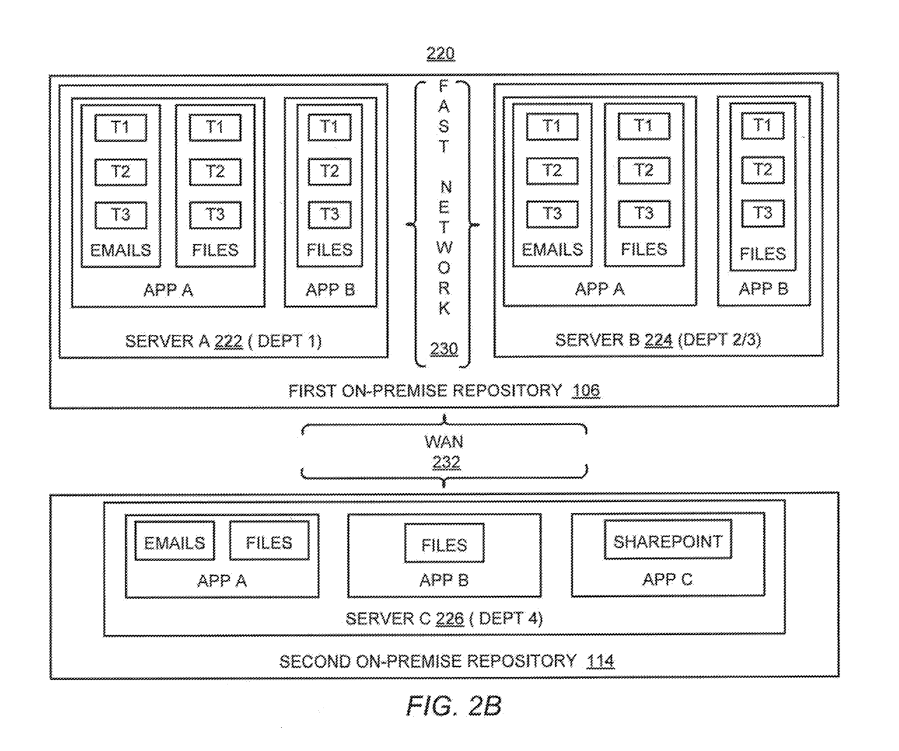

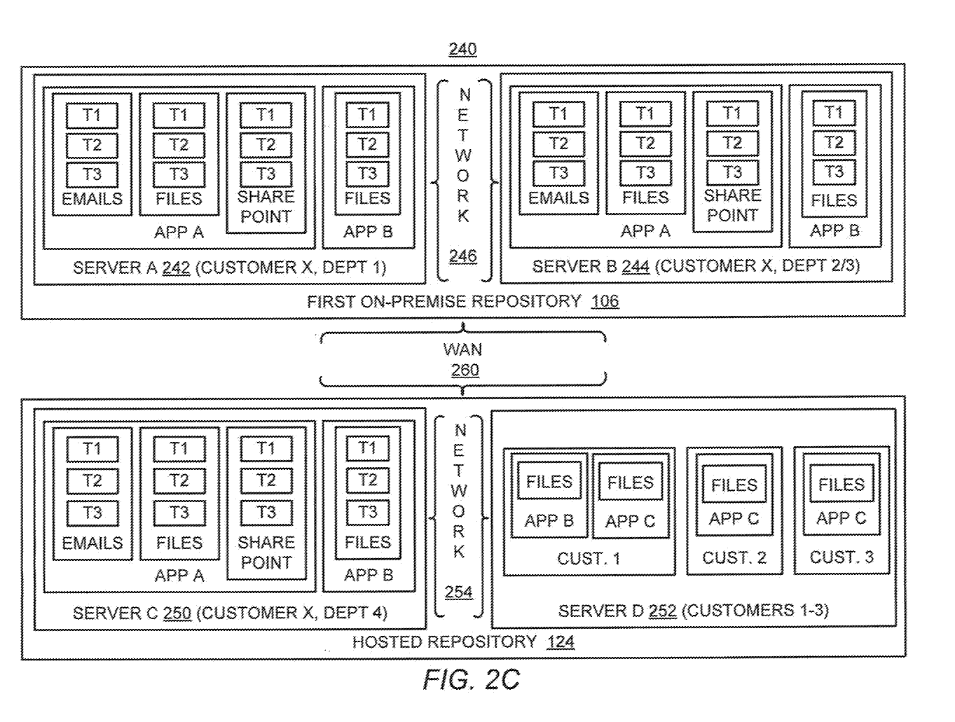

Turning now to FIGS. 2A-2C, there are respectively illustrated various diagrams 200, 220, 240 of manners in which the partitioning strategy may be implemented on at least one of the repositories 106, 114, 124, according to examples of the present disclosure. It should be understood that the diagrams depicted in FIGS. 2A-2C may include additional components and that one or more of the components described therein may be removed and/or modified without departing from a scope of the data management environment 100. It should also be clearly understood that the diagrams depicted in FIGS. 2A-2C comprise examples of manners in which the components of the data management environment 100 may be implemented, and that other examples are within the realm and scope of the data management environment 100. In addition, although the partitions have been depicted in the FIGS. 2A-2C as being assigned within respective servers, it should be understood that the partitions may additionally span multiple servers, groups of servers, and/or repositories without departing from a scope of the data management environment 100 disclosed herein.

With reference first to FIG. 2A, the diagram 200 depicts a manner in which the hosted repository 124 may be partitioned according to an example partitioning strategy. The hosted repository 124 is depicted as having four servers A-D 202-208 connected to each other through a fast network 210, which may comprise, for instance, a LAN, a switch fabric, etc. In addition, the first server A 202 is depicted as comprising a first partition that is assigned to a first department of a first customer and the second server B 204 is depicted as comprising a second partition that is assigned to a second department and a third department of the first customer. In this regard, the first customer may comprise a relatively large customer for which individual servers 202, 204 have been partitioned to receive data to be stored from various departments of the same customer. As such, the data owned by the group of users in the first department of the first customer may be stored in the first server 202 and the data owned by the group of users in the second and third departments of the first customer may be stored in the second server 204.

The data has also been depicted in FIG. 2A as being stored separately within each of the partitions based upon the types of the data, for instance, whether the data comprises emails, files, sharepoint files, etc. In addition, in FIG. 2A, the partitions are also depicted as comprising various applications (APPs), such as applications pertaining to eDiscovery, archiving, backing up, etc. Moreover, the reference characters “T” represents Time based partitioning, for instance, by day, month, quarter, year, etc.

As also shown in FIG. 2A, the third server C 206 is depicted as comprising a third partition that is assigned to a second customer such that all of the data from the second customer is stored in the third server C 206. Furthermore, the fourth server D 208 is depicted as comprising a fourth partition that is assigned to third, fourth, fifth, sixth, and seventh customers, in which data owned by each of the customers is stored separately with respect to each other.

With reference now to FIG. 2B, the diagram 220 depicts a manner in which the first on-premise repository 106 and the second on-premise repository 114 may be partitioned according to an example partitioning strategy. As discussed above, the first on-premise repository 106 may be geographically separated from the second on-premise repository 114. Thus, according to an example, the first on-premise repository 106 may be located in the United States and the second on-premise repository 114 may be located in India.

The first on-premise repository 106 is depicted as having a first server A 222 and a second server B 224 connected to each other through a fast network 230, which may comprise, for instance, a LAN, a switch fabric, etc. The second on-premise repository 114 is depicted as including a third server 226, in which the second on-premise repository 114 is connected to the first on-premise repository 106 through a wide area network (WAN) 232. The first server A 222 is depicted as comprising a first partition that is assigned to a first department of an organization and the second server B 224 is depicted as comprising a second partition that is assigned to a second department and a third department of the organization. The third server 226 is depicted as comprising a third partition that is assigned to a fourth department of the organization. In addition, the data has been depicted as being stored separately within each of the partitions based upon the types of the data, for instance, whether it the data comprises emails, files, sharepoint files, etc.

With reference now to FIG. 2C, the diagram 240 depicts a manner in which the first on-premise repository 106 and the hosted repository 124 may be partitioned according to an example partitioning strategy. The first on-premise repository 106 is depicted as having a first server A 242 and a second server B 244 connected to each other through a network 246, which may comprise a fast network. The hosted repository 124 is depicted as including a third server 250 and a fourth server 252 connected to each other through a network 254, which may comprise a fast network. In addition, the hosted repository 124 is depicted as being connected to the first on-premise repository 106 through a WAN 260.

In the first on-premise repository 106, the first server A 242 is depicted as comprising a first partition that is assigned to a first department of an organization (customer X) and the second server B 242 is depicted as comprising a second partition that is assigned to a second department and a third department of the organization. In the hosted repository 124, the third server C 250 is depicted as comprising a third partition that is assigned to a fourth department of the organization. In addition, the fourth server D 252 is depicted as comprising a fourth partition that is assigned to first, second, and third customers, in which data owned by each of the customers is stored separately with respect to each other. The data has also been depicted as being stored separately within each of the partitions based upon the types of the data, for instance, whether the data comprises emails, files, sharepoint files, etc. FIG. 2C thus illustrates an example in which an organization's data is stored in a hybrid manner on both the on-premise repository 106 and the hosted repository 124.

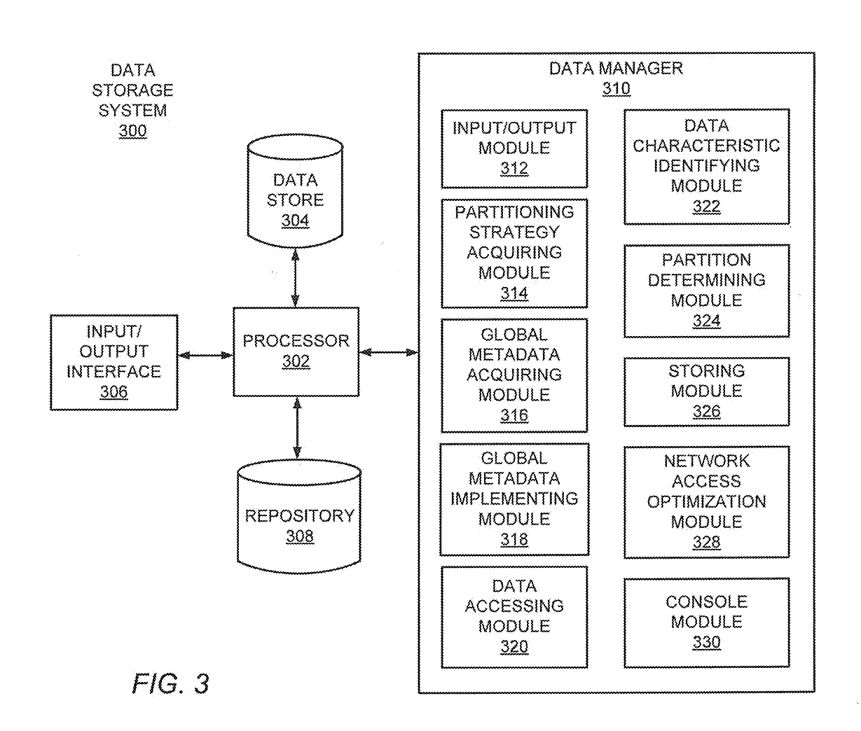

With reference now to FIG. 3, there is shown a block diagram of a data storage system 300, according to an example of the present disclosure. It should be understood that the data storage system 300 may include additional components and that one or more of the components described herein may be removed and/or modified without departing from a scope of the data storage system 300.

According to an example, the data storage system 300 represents a data storage system that may be implemented in any one or all of the organization first location 102, organization second location 110, and the data storage host 120 depicted in FIG. 1. In this example, each of the data managers 104, 112, 122 depicted in FIG. 1 may include the configuration of the data manager 310. In another example, the data manager 310 comprises a separate manager than the data managers 104, 112, 122 depicted in FIG. 1.

The data storage system 300 is depicted as including a processor 302, a data store 304, an input/output interface 306, a repository 308, and a data manager 310. The data storage system 300 comprises, for instance, a server or other electronic apparatus or system that is to perform a method for managing storage of data disclosed herein. Although the repository 308 has been depicted as forming part of the data storage system 300, it should be understood that the repository 308 may be a separate data storage apparatus or a separate array of data storage apparatuses without departing from a scope of the data storage system 300.

The data manager 310 is depicted as including an input/output module 312, a partitioning strategy acquiring module 314, a global metadata acquiring module 316, a global metadata implementing module 318, a data accessing module 320, a data characteristic identifying module 322, a partition determining module 324, a storing module 326, a network access optimization module 328, and a console module 330. The processor 302, which may comprise a microprocessor, a micro-controller, an application specific integrated circuit (ASIC), and the like, is to perform various processing functions in the data storage system 300. One of the processing functions includes invoking or implementing the modules 312-330 contained in the data manager 310 as discussed in greater detail herein below.

According to an example, the data manager 310 comprises a hardware device, such as a circuit or multiple circuits arranged on a board. In this example, the modules 312-330 comprise circuit components or individual circuits. According to another example, the data manager 310 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 312-330 comprise software modules stored in the data manager 310. According to a further example, the modules 312-330 comprise a combination of hardware and software modules.

The input/output interface 306 may comprise a hardware and/or a software interface. In any regard, the input/output interface 306 may be connected to a network, such as the Internet, an intranet, a LAN, a WAN, etc., over which the data manager 310 may receive and communicate data, for instance, documents to be stored. The processor 302 may store data received through the input/output interface 306 in the data store 304 and may use the data in implementing the modules 312-330. The processor 302 may also store data into the repository 308 or may communicate data to be stored in another repository to the other repository, for instance, as determined by the global metadata implementing module 318, as discussed in greater detail herein. The data store 304 comprises volatile and/or non-volatile memory, such as DRAM, EEPROM, MRAM, phase change RAM (PCRAM), Memristor, flash memory, and the like. In addition, or alternatively, the data store 304 comprises a device that is to read from and write to a removable media, such as a floppy disk, a CD-ROM, a DVD-ROM, or other optical or magnetic media. The repository 308 may also comprise a similar type of volatile and/or nonvolatile memory or may comprise a different type of memory.

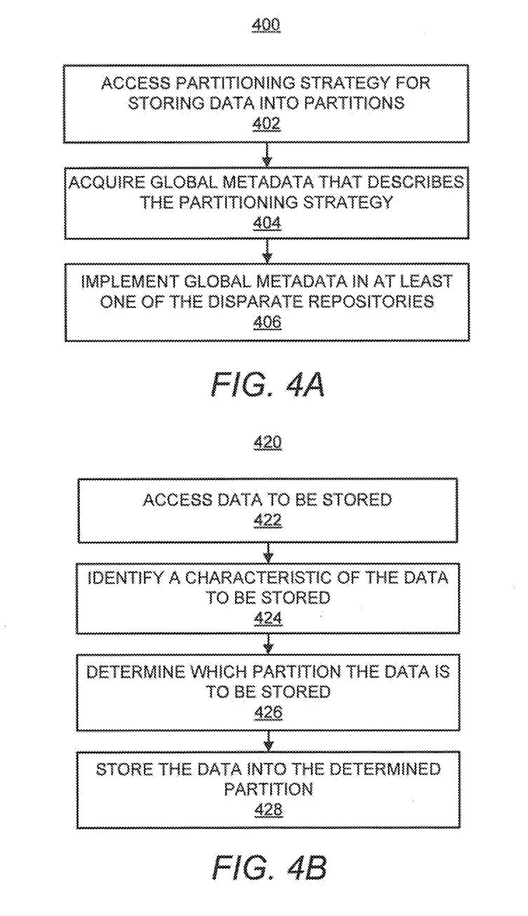

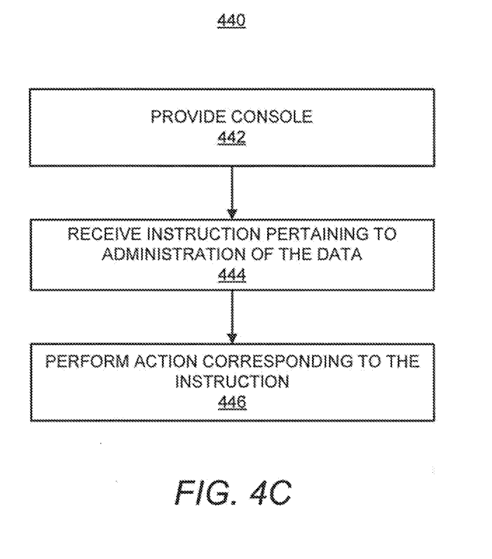

Various manners in which the modules 312-330 of the data manager 310 may be implemented are discussed in greater detail with respect to the methods 400, 420, 440 respectively depicted in FIGS. 4A-4C. Particularly, FIGS. 4A-4C, respectively depict flow diagrams of methods 400, 420, 440 for managing storage of data across a plurality of disparate repositories, according to an example of the present disclosure. It should be apparent to those of ordinary skill in the art that the methods 400, 420, 440 represent generalized illustrations and that other operations may be added or existing operations may be removed, modified or rearranged without departing from the scopes of the methods 400, 420, 440. Although particular reference is made to the data manager 310 depicted in FIG. 3 as comprising an apparatus and/or a set of machine readable instructions that may perform the operations described in the methods 400, 420, 440, it should be understood that differently configured apparatuses and/or machine readable instructions may perform the methods 400, 420, 440 without departing from the scopes of the methods 400, 420, 440.

Generally speaking, the methods 400, 420, 440 may separately be, implemented to manage storage of data across a plurality of disparate repositories. As discussed above, the disparate repositories may comprise repositories 106, 114 located at different locations, but under the control of a common organization. In addition, or alternatively, the disparate repositories may comprise hosted repositories 124 that are hosted by third-party data storage providers, such as cloud-based public data storage providers. As a further alternative, the disparate repositories may comprise a combination of on-premise repositories 106 and hosted repositories 124.

With reference first to FIG. 4A, at block 402, a partitioning strategy for storing the data into a plurality of partitions in at least one of the plurality of disparate repositories 106, 114, 124 based upon a characteristic of the data is acquired, for instance, by the partitioning strategy acquiring module 314. According to an example, the partitioning strategy may be developed, for instance, by an administrator, user, or automatically created, and may be stored in a data storage location, such as the data store 304. In addition, the partitioning strategy acquiring module 314 may obtain the partitioning strategy from the data storage location. As discussed above, the partitioning strategy may be developed, for instance, to cause data owned by different groups of users to be stored in different partitions, in which the different partitions are established in at least one of a plurality of disparate repositories 106, 114, 124. The determination of which groups of users are to be assigned to which partitions may be based upon any suitable policy. For example, the policy may be to cause relatively more important data to be stored into a first partition and to cause relatively less important data to be stored into a second partition, in which the first partition is established in an on-premise repository 106 and the second partition is established in a hosted repository 124 or on a remote on-premise repository 114. As another example, the policy may indicate that the first partition is established in a first hosted repository 124 and that the second partition is established in a second hosted repository 124.

At block 404, global metadata that describes the partitioning strategy is acquired, for instance, by the global metadata acquiring module 316. According to an example, the global metadata that describes the partitioning strategy may be generated, for instance, by an administrator, user, or automatically created, and may be stored in a data storage location, such as the data store 304. In addition, the global metadata acquiring module 316 may obtain the global metadata from the data storage location. In another example, the global metadata acquiring module 316 may generate the global metadata based upon the partitioning strategy acquired at block 402.

At block 406, the global metadata is implemented in at least one of a plurality of disparate repositories to enable performance of the partitioning strategy in storing the data in at least one of the plurality of disparate repositories, for instance, by the global metadata implementing module 318. According to an example, each of the data managers 104, 112, 122 of a plurality of disparate repositories 106, 114, 124 in which the plurality of partitions are to be established implement the method 400 such that the same global metadata is implemented in each of the data managers 104, 112, 122.

In one regard, through implementation of the method 400 in each of the data managers 104, 112, 122, data may be stored across the disparate repositories 106, 114, 124 in a location agnostic manner. In addition, therefore, the data may also be searched, retrieved, and otherwise administered in a location agnostic manner.

Turning now to FIG. 4B, the method 420 generally comprises more detailed operations of the operations contained in block 406 of the method 400, according to an example. As such, the method 420 may be implemented following performance of blocks 402 and 404. Alternatively, the method 420 may be implemented separately from the operations contained in the method 400.

In any regard, at block 422, data to be stored is accessed, for instance, by the data accessing module 320. The data to be stored, which is also referred to herein as simply the “data”, may be accessed in any of a variety of manners. According to an example, the data is stored in the data store 304 of the data storage system 300 and the data manager 310 accesses the data from the data store 304. In another example, the data is stored in a separate location, for instance, on a client device that is in communication with the data storage system 300 through the input/output interface 306. In any regard, a user may manually initiate the storing of the data or the data may be accessed automatically by the data manager 310 as part of a scheduled or routine storing operation.

At block 424, a characteristic of the data to be stored is identified, for instance, by the data characteristic identifying module 322. As discussed above, the characteristic of the data to be stored may comprise at least one of an owner of the data, a type of the data, an identifier of an owner of the data, a group identifier of the data, etc. According to a particular example, a characteristic of the data to be stored comprises a group in which the owner of the data belongs. In any regard, the characteristic of the data may be identified, for instance, from metadata contained in the data, from a user identification associated with the data, etc.

At block 426, a determination is made as to which partition of the plurality of partitions the data is to be stored based upon the identified characteristic of the data and the global metadata, for instance, by the partition determining module 324. Particularly, for instance, a determination may be made as to which partition the global metadata, and specifically, the partitioning strategy, indicates the data is to be stored based upon the characteristic of the data. For instance, as discussed above, the partitioning strategy may indicate that data having a first characteristic is to be stored into a first partition, data having a second characteristic is to be stored into a second partition, data having a third characteristic is to be stored into a third partition, etc. As also discussed above, and according to an example, the partitioning strategy may indicate that the data is to be stored into a local on-premise repository 106, a remote on-premise repository 114, and/or a hosted repository 124.

At block 428, the data is stored into the determined partition, for instance, by the storing module 326. As discussed above, the data may be stored into a local on-premise repository 106, a remote on-premise repository 114, and/or a hosted repository 124. As such, the mechanism(s) through which the data is stored may vary depending upon the repository 106, 114, 124 into which the data is stored. For instance, the storing of the data may comprise communicating the data across a LAN, a WAN, and/or the Internet to at least one of the repositories 106, 114, 124.

According to an example, implementation of either or both of the methods 400 and 420 generally enable transparent capture of data into the partitions of at least one of the disparate repositories, 106, 114, 124. The transparency of the capture of the data may be considered with respect to the user that is storing the data. In addition, the data that is stored in the disparate repositories, 106, 114, 124 may further be administered in a manner that is transparent to a user. An example of a manner in which a user may perform administrative functions on the stored data is described with respect to the method 440 depicted in FIG. 4C, more particularly, the method 440 comprises operations that may additionally be implemented following implementation of either or both of the methods 420, according to an example.

At block 442, a console is provided through which administration of the data stored in at least one of the plurality of disparate repositories 106, 114, 124 is facilitated, for instance, by the console module 330. According to an example, the console may comprise, for instance, a web-based interface or portal through which a user may submit requests for data to be stored in the data management environment 100. The console may also comprise a web-based interface or portal through which a user may perform administrative functions on the stored data. By way of example, the administrative functions include at least one of the setting of retention policies, the monitoring of job (e.g., indexing, disposition, etc.) statuses, the searching for particular stored data, the requesting and retrieval of particular data, etc. Because a common console that provides administrative functions to each of the plurality of disparate repositories 106, 114, 124 is provided, the administrative functions may be provided on the plurality of disparate repositories 106, 114, 124 in a manner that renders the location at which the data is stored and the manner in which the data is searched and/or retrieved to be transparent to the user that performs the administrative functions on the data.

At block 444, an instruction pertaining to administration of the data is received, for instance, by the console module 330. Particularly, the console module 330 may receive input from a user for a particular action to be taken with respect to the data stored in at least one of the plurality of disparate repositories 106, 114, 124. The particular actions that may be included in the received input may comprise, for instance, at least one of performing a search on the stored data, setting of retention policies, etc. By way of example, the user may perform the search to encompass data stored in a specified set of partitions, for instance, which may comprise data stored in a single partition, a plurality of partitions, or all of the partitions in at least one of the disparate repositories 106, 114, 124.

At block 446, an action corresponding to the received instruction is performed, for instance, by the console module 330. According to an example, the action is performed in a manner that may not reveal the actual location in which the data upon which the action is performed is stored. In one regard, the method 400 may enable users to perform the administrative functions on the stored data in a location agnostic or relatively seamless manner. More particularly, for instance, through implementation of the partitioning strategy discussed above with respect to method 400, the data is stored according to a common strategy among the plurality of disparate repositories 106, 114, 124. In this regard, the partitioning strategy may also be used to perform administrative functions in a location agnostic manner on the stored data since the partitioning strategy enables identification of and access to the data storage locations, regardless of the disparate repositories 106, 114, 124 at which the data is stored.

According to an example, access to the stored data may substantially be optimized, for instance, by the network access optimization module 328. As discussed above, because the data may be stored on any of the disparate repositories 106, 114, 124 and because connections to the disparate repositories 106, 114, 124 may differ, manners in which the data may be retrieved from the disparate repositories. 106, 114, 124 may differ with respect to each other. For instance, retrieving data over a WAN may be relatively slower than retrieving data over a LAN. In one regard, therefore, the network access optimization module 328 may accommodate slower delivery of the data, for instance, through various compression schemes. More particularly, the network access optimization module 328 may apply a suitable compression scheme that accommodates for the manners in which data is able to be communicated over a network. In addition, the network access optimization module 328 may apply other schemes to enable the data to traverse various types of firewalls. By way of particular example, for fast interconnects over LAN, because security and speed concerns aren't as large a concern as they are for connections over WAN, the network access optimization module 328 may skip encryption and compression of the data when the data is communicated over fast interconnects. In addition, for fast interconnects over LAN, the network access optimization module 328 may modify the order in which the data is retrieved, for instance, modify the priority order of the data, which may not be possible with data that is communicated over WAN.

Some or all of the operations set forth in the methods 400, 420, 440 may be contained as a utility, program, or subprogram, in any desired computer accessible medium. In addition, the methods 400, 420, 440 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

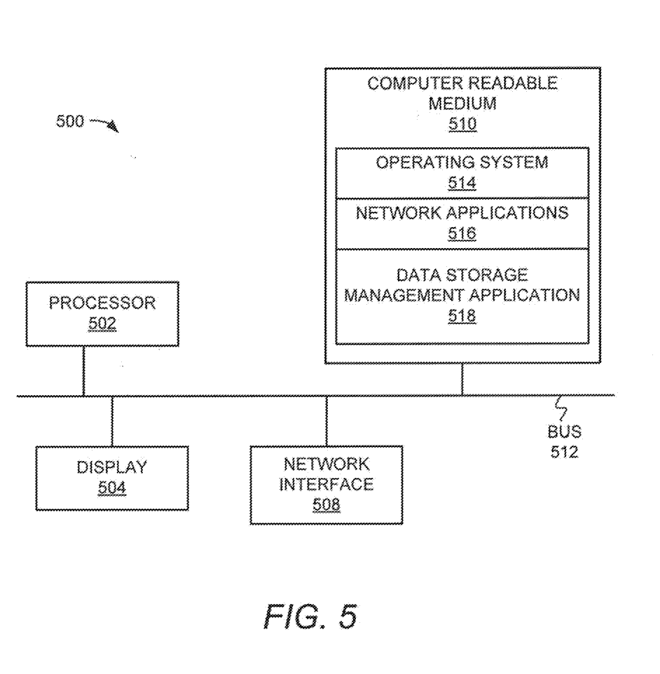

Turning now to FIG. 5, there is shown a schematic representation of a computing device 500, which may be employed to perform various functions of the data manager 310 depicted in FIG. 3, according to an example. The computing device 500 includes a processor 502, such as but not limited to a central processing unit; a display device 504, such as but not limited to a monitor; a network interface 508, such as but not limited to a Local Area Network LAN, a wireless 802.11x LAN, a 3G mobile WAN or a WiMax WAN; and a computer-readable medium 510. Each of these components is operatively coupled to a bus 512. For example, the bus 512 may be an EISA, a PCI, a USB, a FireWire, a NuBus, or a PDS.

The computer readable medium 510 comprises any suitable medium that participates in providing instructions to the processor 502 for execution. For example, the computer readable medium 510 may be non-volatile media, such as memory. The computer-readable medium 510 may also store an operating system 514, such as but not limited to Mac OS, MS Windows, Unix, or Linux; network applications 516; and a data archiving management application 518. The operating system 514 may be multi-user, multiprocessing, multitasking, multithreading, real-time and the like. The operating system 514 may also perform basic tasks such as but not limited to recognizing input from input devices, such as but not limited to a keyboard or a keypad; sending output to the display 504; keeping track of files and directories on medium 510; controlling peripheral devices, such as but not limited to disk drives, printers, image capture device; and managing traffic on the bus 512. The network applications 516 include various components for establishing and maintaining network connections, such as but not limited to machine readable instructions for implementing communication protocols including TCP/IP, HTTP, Ethernet, USB, and FireWire.

The data storage management application 518 provides various components for managing storage of data as discussed above with respect to the methods 400, 420, and 440 in FIGS. 4A-4B. The data storage management application 518 may thus comprise the input/output module 312, the partitioning strategy acquiring module 314, the global metadata acquiring module 316, the global metadata implementing module 318, the data accessing module 320, the data characteristic identifying module 322, the partition determining module 324, the storing module 326, the network access optimization module 328, and the console module 330. In this regard, the data storage management application 518 may include modules for performing the methods 400, 420, 420.

In certain examples, some or all of the processes performed by the application 518 may be integrated into the operating system 514. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for managing storage of data across a plurality of disparate repositories, said method comprising:
acquiring a partitioning strategy for storing the data into a plurality of partitions in at least one of the plurality of disparate repositories based upon a characteristic of the data;
acquiring global metadata that describes the partitioning strategy; and
implementing, by a processor, the global metadata in at least one of the plurality of disparate repositories to, enable performance of the partitioning strategy in storing the data in the plurality of partitions across the plurality of disparate repositories in a location agnostic manner.

2. The method according to claim 1, wherein implementing the global metadata further comprises implementing the global metadata to establish the plurality of partitions in at least one of the disparate repositories, wherein each of the plurality of partitions corresponds to a logical separation of the data based upon the characteristic of the data, wherein the characteristic of the data comprises an owner of the data, and wherein implementing the global metadata further comprises implementing the global metadata to establish the plurality of partitions in at lest one of the disparate repositories to store data owned by respective groups of users.

3. The method according to claim 2, wherein the plurality of disparate partitions are logically partitioned with respect to each other according to a manner in which the groups of users are organized in an organization.

4. The method according to claim 1, wherein the plurality of disparate repositories comprise at least two of an on-premise repository, a hosted repository, and a geographically remote repository.

5. The method according to claim 4, wherein a first repository of the plurality of disparate repositories comprises an on-premise repository and wherein a second repository of the plurality of disparate repositories comprises a hosted repository, wherein the partitioning strategy further comprises assigning the plurality of partitions to respective groups of users, and wherein the global metadata describes the partitioning strategy as assigning a first group of users to the first repository and assigning a second group of users to the second repository.

6. The method according to claim 5, wherein data owned by the first group of users has a greater relative importance than data owned by the second group of users.

7. The method according to claim 1, wherein the partitioning strategy further comprises storing multiple copies of the same data in multiple partitions on at least one of the plurality of disparate repositories.

8. The method according to claim 1, wherein the characteristic of the data comprises at least one of an owner of the data, a type of the data, an identifier of the owner of the data, and a group identifier of the data.

9. The method according to claim 1, wherein implementing the global metadata further comprises:
accessing data to be stored;
identifying a characteristic of the data to be stored;
determining which partition of the plurality of partitions the data is to be stored based upon the identified characteristic of the data and the global metadata; and
storing the data into the determined partition.

10. The method according to claim 1, further comprising:
providing a console through which administration of the data stored in at least one of the plurality of disparate repositories is facilitated;
receiving an instruction pertaining to administration of the data stored in the at least one of the plurality of disparate repositories through the console; and
performing an action corresponding to the received instruction.

11. An apparatus for managing storage of data across a plurality of disparate repositories, said apparatus comprising:
at least one module to,
acquire a partitioning strategy for storing the data into a plurality of partitions based upon a characteristic of the data, wherein the plurality of partitions are established across the plurality of disparate repositories;
acquire global metadata that describes the partitioning strategy; and
implement the global metadata in the plurality of disparate repositories to perform the partitioning strategy in storing the data in the plurality of partitions across the plurality of disparate repositories; and
a processor to implement the at least one module.

12. The apparatus according to claim 11, wherein each of the plurality of partitions corresponds to a logical separation of the data based upon the characteristic of the data, and wherein the plurality of disparate repositories comprise at least two of an on-premise repository, a hosted repository, and a geographically remote repository.

13. The apparatus according to claim 11, wherein the at least one module is further to:
access data to be stored;
identify a characteristic of the data;
determine which partition of the plurality of partitions the data is to be stored based upon the identified characteristic of the data and information contained in the global metadata; and
store the data into the determined partition.

14. The apparatus according to claim 11, wherein the at least one module is further to:
provide a console through which administration of the data stored in at least one of the plurality of disparate repositories is facilitated;
receive an instruction pertaining to administration of the data stored in the plurality of disparate repositories through the console; and
perform an action corresponding to the received instruction.

15. A non-transitory computer readable storage medium on which is stored machine readable instructions that when executed by a processor, implement a method for managing storage of data across a plurality of disparate repositories, said machine readable instructions comprising code to:
acquire a partitioning strategy for storing the data into a plurality of partitions in at least one of the plurality of disparate repositories based upon a characteristic of the data, wherein the plurality of partitions are established on the plurality of disparate repositories;
acquire global metadata that describes the partitioning strategy; and
implement the global metadata in the plurality of disparate repositories to perform the partitioning strategy in storing the data in the plurality of partitions across the plurality of disparate repositories.
